(19) United States
(12) Patent Application Publication
(10) Pub. No.: US 2026/0066788 A1
(43) Pub. Date: Mar. 5, 2026

(54) LINE FEEDFORWARD COMPENSATION FOR TIME-BASED BUCK CONVERTER WITH FEEDBACK PROPORTIONAL-INTEGRAL-DERIVATIVE (PID) CONTROL

(71) Applicant: STMicroelectronics International N.V., Geneva (SE)

(72) Inventors: Alessandro BERTOLINI, Vermiglio (IT); Alessandro GASPARINI, Cusano Milanino (IT); Paolo MELILLO, Caltanissetta (IT); Massimo GHIONI, Monza, MB (IT); Salvatore LEVANTINO, Milano (IT)

(73) Assignee: STMicroelectronics International N.V., Geneva (CH)

(21) Appl. No.: 18/825,210

(22) Filed: Sep. 5, 2024

(51) Int. Cl. H02M 3/158; H02M 1/00

(52) U.S. Cl. CPC H02M 3/158; H02M 1/0022

(57) ABSTRACT

This disclosure describes a DC-DC converter with improved response to input voltage variations. The converter employs a feedback-PID structure with a fast injection circuit and fine correction circuit to regulate output voltage. The fast injection circuit produces rapid duty cycle adjustments in response to input voltage changes, implementing a feedforward path. The fine correction circuit works with the fast injection circuit to provide integral action. A low-pass filter and the fine correction circuit create a bandpass filtering. The control loop includes a proportional-integral and a phase detection circuit to generate the final driving signal. A multiplier circuit tracks the input voltage and produces a control current proportional to the steady-state duty cycle. This approach enables fast response to input variations and precise long-term regulation while effectively managing noise across different frequency ranges.

### TECHNICAL FIELD

This disclosure relates to control methods and circuits for DC-DC converters, particularly to systems that combine fast feedforward control with proportional-integral-derivative (PID) feedback control to achieve rapid response to input voltage changes and precise long-term regulation while managing noise and disturbances across various frequency ranges.

### BACKGROUND

Time-based control has emerged as a choice for high-frequency DC-DC converters due to its advantages over traditional voltage-based or digital control methods. In time-based control, the duty cycle of the DC-DC converter is directly modulated by adjusting the on-time and off-time of the power switches of the DC-DC converter. This is achieved by using a VCO (voltage-controlled oscillator) and a VCDL (voltage-controlled delay line) to elaborate the signal in the phase domain. By using a simple phase-detector (PD), which replaces the PWM comparator, the on-time and the off-time of the power switch is modulated, eliminating components such as the error amplifier and the PWM comparator that consume excess power. By eliminating these bulky and power-hungry components, time-based control results in a more compact and energy-efficient control system.

Line feedforward is a technique used to improve the transient response of the DC-DC converter to input voltage variations, helping maintain a stable output voltage. In time-based control, line feedforward is typically implemented using additional circuitry that works alongside the main control loop. This circuitry continuously measures the input voltage and uses this information to adjust the timing of the power switches of the DC-DC converter. The control system then modifies the on-time or off-time of the power switches based on these measurements, effectively adjusting the duty cycle. By doing so, the system can compensate for input voltage variations before they significantly impact the output voltage. This proactive approach helps minimize the effect of input voltage fluctuations on the performance of the DC-DC converter, resulting in improved transient response and more stable output voltage.

However, this approach has several drawbacks. The additional circuitry required for implementing line feedforward occupies significant area, increases power consumption, and can add complexity to the control loop. Furthermore, the line feedforward circuitry must be carefully designed and tuned to provide for suitable performance across a range of operating conditions. The added complexity can also increase the risk of stability issues if not implemented correctly. An example known implementation is shown in Melillo, Paolo, et. al. “A Wide-Input-Range Time-Based Buck Converter With Adaptive Gain and Continuous Phase Preset for Seamless PFM/PWM Transitions” IEEE Transactions on Circuits and Systems I: Regular Papers. IEEE, 2024. This paper shows buck converter that employs time-based control with adaptive gain compensation and a line feedforward technique. The converter utilizes both pulse-width modulation (PWM) and pulse-frequency modulation (PFM) modes. The time-based control architecture uses a proportional-integral-derivative (PID) control implemented in the time domain. Adaptive gain compensation is employed. The converter incorporates a feedforward mechanism to improve line transient response and enable seamless transitions between PFM and PWM modes. This feedforward is implemented using two additional wide-range linear current-controlled delay lines. While effective, these delay lines consume significant chip area and power, which could be considered a drawback of the approach.

The Bertolini patent publication (US20240128871A1) introduces a feedback-PID (Proportional-Integral-Derivative) control system for DC-DC boost converters. This approach incorporates an additional path to introduce feedforward control within the feedback-PID structure. By utilizing this design, the invention of the patent publication aims to eliminate the need for an additional delay line in the control system. However, the implementation of a feedback-PID with line feedforward in a buck converter is not straightforward.

As such, despite these advances, methods are needed for implementing line feedforward in buck converters with time-based control, aiming to improve efficiency, reduce size, and simplify the design while maintaining or enhancing the transient response of the DC-DC converter to input voltage variations.

### SUMMARY

A circuit includes a DC-DC converter circuit to generate an output voltage from an input voltage. A control circuit is coupled to the DC-DC converter circuit. The control circuit has a fast injection circuit to receive the input voltage and a driving signal, a fine correction circuit coupled to the fast injection circuit, a proportional-integral circuit, and a phase detection circuit. The control circuit generates fast duty cycle variations in response to changes in the input voltage, provides integral action to account for efficiency variations and eliminate steady-state errors, implements an equivalent proportional-integral-derivative control, and generates a final driving signal based on outputs of the proportional-integral circuit, to perform a proportional-integral-derivative filtering.

The control circuit may have a low-pass filter coupled between the fast injection circuit and a reference voltage. The low-pass filter and fine correction circuit together may create a bandpass characteristic.

The fast injection circuit may have a voltage-to-current converter arrangement, a current mirror coupled to the voltage-to-current converter arrangement, and a multiplier circuit coupled to the current mirror.

The multiplier circuit may receive a current from the current mirror proportional to the input voltage, receive a set current, receive a current from an integral loop and generate a control current proportional to a ratio of the output voltage to the input voltage.

The proportional-integral circuit may have a first current controlled oscillator responsive to transconductance outputs provided by noninverting outputs of first and third transconductance amplifiers, a second current controlled oscillator responsive to transconductance outputs provided by inverting outputs of the first and third transconductance amplifiers, a first current controlled delay line responsive to transconductance outputs provided by noninverting outputs of second and fourth transconductance amplifiers, and a second current controlled delay line responsive to transconductance outputs provided by inverting outputs of the second and fourth transconductance amplifiers.

The proportional-derivative circuit may generate the driving signal based on outputs of the first and second current controlled delay lines.

A method of controlling a DC-DC converter includes generating fast variations in a driving signal duty cycle of the DC-DC converter in response to changes in an input voltage, integrating an error between a feedback voltage and a reference voltage to account for efficiency variations of the DC-DC converter and eliminate steady-state output voltage errors, implementing proportional and integral control on the error between the feedback voltage and the reference voltage, generating a final driving signal for a power stage of the DC-DC converter based on outputs of the proportional and integral control, and controlling the power stage of the DC-DC converter using the final driving signal to generate an output voltage from the input voltage.

The method may include creating a bandpass filtering for a feedforward signal by generating a control current proportional to a ratio of the output voltage to the input voltage, injecting the control current into a low-pass filter to produce the feedforward signal, and combining the low-pass filter with a fine correction circuit. The bandpass filtering may optimize the response of the DC-DC converter to different frequencies of disturbances in the input voltage and output voltage by rejecting high-frequency noise while allowing the DC-DC converter to respond to relevant frequency components of the disturbances.

Generating fast variations in the driving signal duty cycle may include a multiplier circuit taking as input a feedforward current proportional to the input voltage, generated by means of a resistor and a current mirror, a set current generated by a current reference, and a current from an integral loop, generated by a voltage-to-current arrangement. The multiplier output current feds the low-pass filter which produces a feedforward voltage, input of the first and the second transconductance amplifiers.

Implementing proportional and integral control may include receiving the feedforward signal at non-inverting inputs of first and second transconductance amplifiers, receiving the reference voltage at inverting inputs of the first and second transconductance amplifiers, generating a first transconductance amplifier output and a second transconductance amplifier output from the first transconductance amplifier, and a third transconductance amplifier output and a fourth transconductance amplifier output from the second transconductance amplifier, based on a difference between the feedforward signal and the reference voltage, generating oscillator signals using a feedback current controlled oscillator responsive to noninverting outputs of first and third transconductance amplifiers and a reference current controlled oscillator responsive to inverting outputs of the first and the third transconductance amplifier outputs, delaying the oscillator signals using a feedback current controlled delay line responsive to noninverting outputs of second and fourth transconductance amplifiers and a reference current controlled delay line responsive to inverting outputs of the second and fourth transconductance amplifiers to produce phase-shifted signals, and generating the final driving signal based on the phase-shifted signals using a phase-detection circuit.

### BRIEF DESCRIPTION OF THE DRAWINGS

FIG. 1 is a schematic block diagram of a DC-DC converter disclosed herein.

FIG. 2 is the small-signal model of the DC-DC converter of FIG. 1.

FIG. 3 is a schematic diagram of the DC-DC converter disclosed herein.

FIG. 4 is a schematic diagram of the multiplier circuit of FIG. 3.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Note that in the following description, any resistor or resistance mentioned is a discrete device, unless stated otherwise, and is not simply an electrical lead between two points. Therefore, any resistor or resistance connected between two points has a higher resistance than a lead between those two points, and such resistor or resistance cannot be interpreted as a lead. Similarly, any capacitor or capacitance mentioned is a discrete device, unless stated otherwise, and is not a parasitic element, unless stated otherwise. Additionally, any inductor or inductance mentioned is a discrete device, unless stated otherwise, and is not a parasitic element, unless stated otherwise.

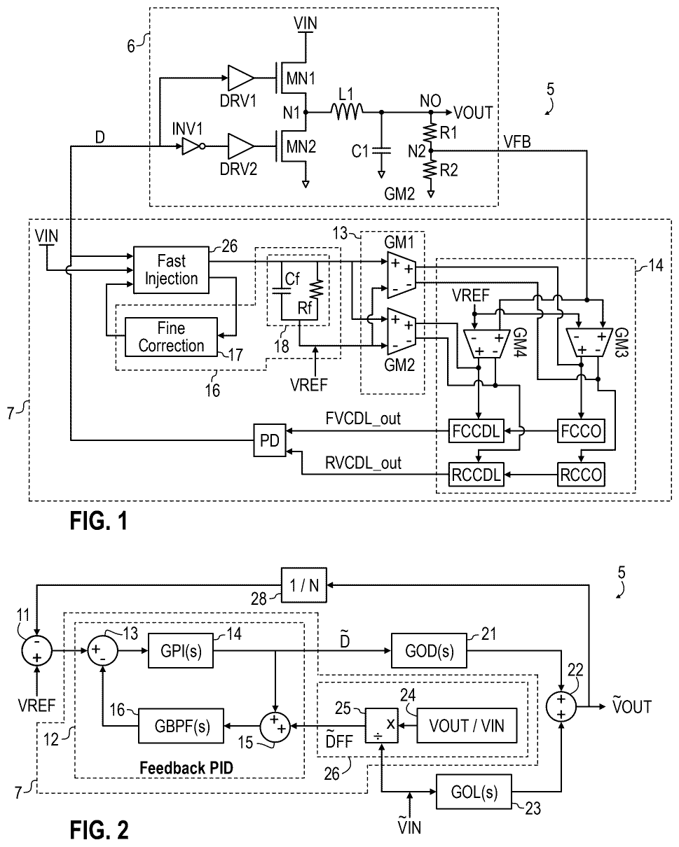

Disclosed herein is a DC-DC converter 5. A general block diagram of the DC-DC converter 5 is shown in FIG. 1.

Referring to FIG. 1, the DC-DC converter 5 includes a converter circuit 6 and a control circuit 7. The converter circuit 6 includes an n-channel power transistor MN1 having its drain connected to an input voltage node to receive an input voltage VIN, its source connected to node N1, and its gate receiving a first driving signal from a first driver DRV1, and an n-channel power transistor MN2 having its drain connected to node N1, its source connected to a ground node, and its gate receiving a second driving signal from a second driver DRV2. An inductor L1 is connected between node N1 and an output node NO, and an output capacitor C1 is connected between output node NO and the ground node. A first feedback resistor R1 is connected between nodes NO and N2, and a second feedback resistor R2 is connected between node N2 and the ground node, with a feedback voltage VFB being formed at node N2. The first driver DRV1 generates the first driving signal based upon driving signal D generated by the control circuit 7, and the second driver DRV2 generates the second driving signal based on the output from inverter INV1, which inverts driving signal D.

The control circuit 12 implements an equivalent proportional-integral-derivative (PID) loop, and includes a fast injection circuit 26 that receives as input the driving signal D, the input voltage VIN, and the output from a fine correction circuit 17. The output of the fast injection circuit 26 is provided to the input of the fine correction circuit 17, as well as to the non-inverting inputs of transconductance amplifiers GM1 and GM2 13, within a summation/subtraction block. A low-pass filter 18 is connected between the output of the fast injection circuit 26 and a reference voltage VREF, and includes a filter capacitor Cf and filter resistor Rf connected in parallel between the output of the fast injection circuit 26 and the reference voltage VREF.

The transconductor block 13 includes a first transconductance amplifier GM1 having its non-inverting input terminal coupled to receive the output of the fast injection circuit 26, its inverting input terminal coupled to receive the reference voltage VREF, and its outputs connected to the proportional-integral circuit 14. The transconductor block 13 further includes a second transconductance amplifier GM2 having its non-inverting input terminal coupled to receive the output of the fast injection circuit 26, its inverting input terminal coupled to receive the reference voltage VREF, and its outputs connected to the proportional-integral circuit 14.

The proportional-integral circuit 14 includes a third transconductance amplifier GM3 having its non-inverting input terminal connected to receive the feedback voltage VFB, its inverting input terminal connected to receive the reference voltage VREF, and its outputs directly connected to provide inputs to a feedback current controlled oscillator FCCO and a reference current controlled oscillator RCCO.

The proportional-integral circuit 14 further includes a fourth transconductance amplifier GM4 having its non-inverting input terminal connected to receive the feedback voltage VFB, its inverting input terminal connected to receive the reference voltage VREF, and its outputs directly connected to provide current inputs to a feedback current controlled delay line FCCDL and a reference current controlled delay line RCCDL. The feedback current controlled delay line FCCDL has an input receiving a signal output by the FCCO, and the reference current controlled delay line RCCDL has an input receiving a signal output by the RCCO. The output of the FCCDL is a delayed signal FVCDL_out and the output of the RCCDL is a delayed signal RVCDL_out. A phase detection circuit PD receives the delayed signal FVCDL_out and the delayed signal RVCDL_out, and generates the drive signal D based thereupon.

Operation is now described. The DC-DC converter 5 employs a feedback-PID structure to regulate its output voltage. This structure provides an alternative path to implement line feedforward, enhancing the response of the DC-DC converter 5 to input voltage variations.

The control circuit 7 implements two main actions, namely fast injection and fine correction.

The fast injection circuit 26 receives the input voltage VIN and the driving signal D. It produces fast duty cycle variations in response to changes in VIN, effectively implementing a feedforward path for input voltage variations. This allows the converter to quickly adjust its operation in response to input voltage changes, improving transient response.

The fine correction circuit 17 works in conjunction with the fast injection circuit 26 to provide integral action. This accounts for efficiency variations and helps eliminate steady-state errors. The feedback loop formed by these two circuits ensures accurate long-term regulation of the output voltage.

The combination of the low-pass filter LPF 18 and the fine correction circuit 17 creates a bandpass characteristic. This filtering helps optimize the system's response to different frequencies of disturbances, rejecting high-frequency noise while still allowing the system to respond to relevant frequency components.

The proportional-integral circuit 14 implements the proportional and integral parts of the PID control. The phase detection circuit PD then uses the outputs FVCDL_out and RVCDL_out of these delay lines to generate the final driving signal D.

This combination of fast feedforward action and slower integral correction allows the DC-DC converter 5 to maintain a stable output voltage (VOUT) in the face of both rapid input voltage changes and long-term efficiency variations. The feedback voltage VFB, derived from the output voltage through the resistive divider (R1 and R2), provides the feedback signal for closed-loop control.

This approach enables the DC-DC converter to achieve both fast response to input variations and precise long-term regulation, while effectively managing noise and disturbances across different frequency ranges.

The small-signal model of the DC-DC converter 5 is now described with reference to FIG. 2, representing the control and feedback mechanisms of the circuit shown in FIG. 1. The model begins with a summing junction 11 that subtracts the feedback signal from the reference voltage VREF. The resulting error feeds into the feedback PID block 12, which corresponds to the control circuit 7 in FIG. 1.

Within block 12, the error signal passes through a GPI(s) block 14, representing the transfer function of the proportional-integral control function implemented by transconductance amplifiers GM3 and GM4 along with the current controlled oscillators and delay lines in FIG. 1. The output of GPI(s) 14 combines at summing junction 15 with the output of the fast injection circuit 26. The GBPF(s) block 16 represents the transfer function of the bandpass filtering action created by the combination of the low-pass filter 18 and the fine correction circuit 17 in FIG. 1.

The model includes a feedforward path that begins with block 24, which outputs a signal representative of the output voltage VOUT divided by the input voltage VIN. This signal is then divided in block 25 by the small signal variation of the input voltage VIN to produce a small signal intermediate driving signal DFF. This DFF serves as an input of the summing block 15, implementing the fast injection functionality of circuit 26 in FIG. 1.

The output of the feedback PID block 12, shown as D to represent the small signal driving signal D, feeds into a GOD(s) block 21, which represents the open-loop transfer function of the power stage of the DC-DC converter 5, including the effects of transistors MN1 and MN2, inductor L1, and output capacitor C1 from FIG. 1. The signal D serves also as input of the summing block 15. The output of the summing node 15 is the input of the GBPF(s) block 16. Similarly, the small signal input voltage VIN passes through the GOL(s) block 23, which represents the transfer function accounting for the direct effect of input voltage variations on the output.

The outputs of GOL(s) and GOD(s) blocks are summed at junction 22 to produce the small signal output voltage VOUT. This output voltage is then fed back through a 1/N block 28, which represents the voltage divider formed by resistors R1 and R2 in FIG. 1. The scaled feedback signal completes the loop by returning to the initial summing junction 11.

This small signal model represents how the DC-DC converter regulates its output voltage, incorporating both feedback and feedforward mechanisms to account for variations in input voltage and other disturbances.

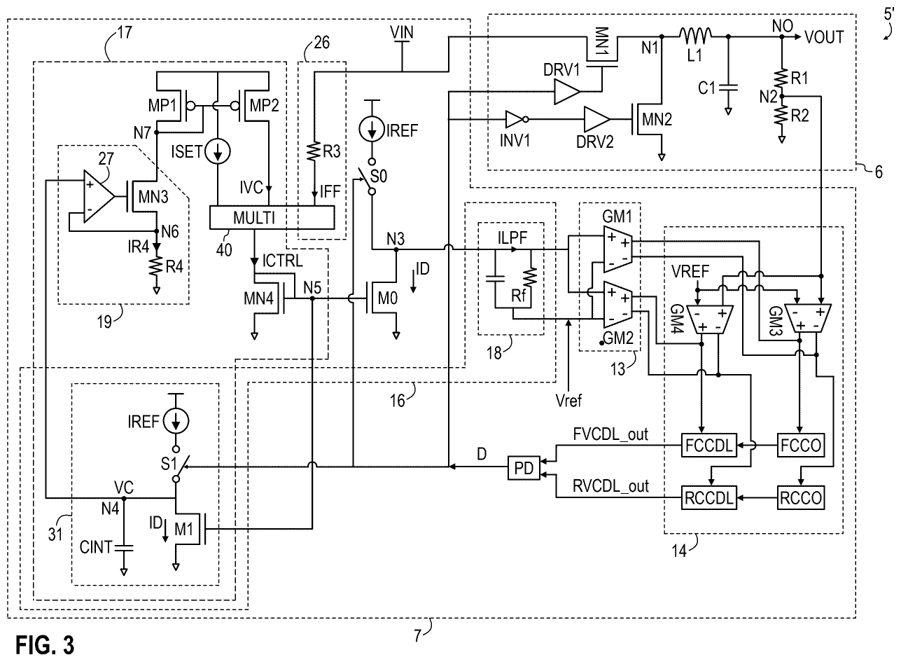

A specific example embodiment of the DC-DC converter 5′ is now described with reference to FIG. 3. Here, the converter circuit 6, transconductor block 13, proportional-integral circuit 14, and LPF 18 are as described above for the DC-DC converter 5.

The fine correction circuit 31 here includes a switch Si, operated based upon the drive signal D received from the proportional-derivative circuit PD, that selectively couples a reference current IREF from to be sourced to node N4. An n-channel transistor M1 has its drain connected to node N4 and its source connected to ground, with its gate connected to node N5. An integration capacitor CINT is connected between node N4 and ground, with a voltage VC being formed at node N4.

The voltage to current conversion circuit 19 here includes an amplifier 27 having its non-inverting input connected to node N4 and its inverting input connected to node N6. N-channel transistor MN3 has its drain connected to node N7, its source connected to node N6, and its gate receiving the output of amplifier 27. A resistor R4 is connected between node N6 and ground. Thus, amplifier 27, n-channel transistor MN3, and resistor R4 form a voltage to current conversion circuit which converts the voltage VC to a corresponding current IR4 that is mirrored by MP1/M2 as IVC.

A current mirror formed by p-channel transistors MP1 and MP2 mirrors and scales the drain current of n-channel transistor MN3 as the current IVC as input to multiplier circuit 40. In greater detail, p-channel transistor MP1 has its source connected to the input voltage VIN, its drain connected to node N7, and its gate connected to the gate of p-channel transistor MP2 as well as to node N7. P-channel transistor MP2 has its source connected to the input voltage VIN, its drain connected to the multiplier circuit 40 to source the current IVC thereto, and its gate connected to the gate of p-channel transistor MP1 as well as to node N7. A set current ISET is sourced to the multiplier circuit 40 as input. A resistor R3 is connected between the input voltage VIN and the multiplier circuit 40, and a current IFF is sourced through resistor R3 to the multiplier circuit 40 as input.

An n-channel transistor MN4 has its drain connected to the output of the multiplier circuit 40 to receive a control current ICTRL sourced thereby, its source connected to ground, and its gate connected to node N5. The control current ICTRL is inversely proportional to the input voltage. An n-channel transistor M0 has its drain connected to node N3, its source connected to ground, and its gate connected to node N5.

A switch S0, operated based upon the drive signal D received from the proportional-derivative circuit PD, selectively coupled the reference current IREF to node N3, with it being noted that the LPF 18 is connected between node N3 and the reference voltage Vref and that the non-inverting inputs of transconductance amplifiers GM1 and GM2 in the summation/subtraction block are connected to node N3.

During operation, the DC-DC converter 5′ in FIG. 3 responds to changes in the input voltage VIN and adjusts the duty cycle accordingly. The overall control loop includes the fast injection circuit 26, the fine correction circuit 17, and the PI control implemented by block 14.

When VIN changes, it affects the current IFF through the multiplier circuit 40, which in turn produces a variation in the current ID through transistor M0. This current ID, mirrored from MN4, injects a current signal ILPF into node N3.

The LPF 18 receives as input the current ILPF, which is the difference between a reference current IREF (modulated by switch S0 controlled by the duty-cycle signal D) and the current ID (proportional to the steady-state duty-cycle, obtained by mirroring the output ICTRL of the multiplier circuit 40 through transistor MN4). The average current injected into the LPF 18 is given by ILPF=DIREF−ID=DIREF−IVC*VOUT/VIN.

The voltage at node N3 represents a fast feedforward signal that rapidly responds to VIN changes. This feedforward voltage is fed into the transconductance amplifiers GM1 and GM2 in the transconductor block 13, which acts as the input stage of the PI compensator.

The outputs of GM1 and GM2 adjust the currents of the current-controlled oscillators FCCO, RCCO and delay lines FCCDL, RCCDL within the proportional-integral circuit 14. This provides an immediate, coarse correction to the phase shift between the FVCDL_out and RVCDL_out signals feeding the phase detection circuit PD, which in turn adjusts the drive signal D.

Fine correction is achieved by the integral loop 17 formed by the fine correction circuit 31 and voltage to current converter 19. This loop includes switch Sl, transistor M1, and capacitor CINT, which integrate the error over time, adjusting the voltage VC at node N4. This voltage VC controls the voltage to current converter circuit 19 formed by amplifier 27, transistor MN3 and the resistor R4, which in turn affects the current IVC.

The multiplier circuit 40 continuously tracks the input voltage VIN, producing a current ICTRL proportional to the steady-state duty-cycle of the converter. At equilibrium, D*IREF=ID and ILPF=0, resulting in VFF=VCM. The integral loop adjusts the voltage VC across CINT until the average current injected by the feedforward path into the LPF 18 is zero, providing for stable operation and accurate regulation.

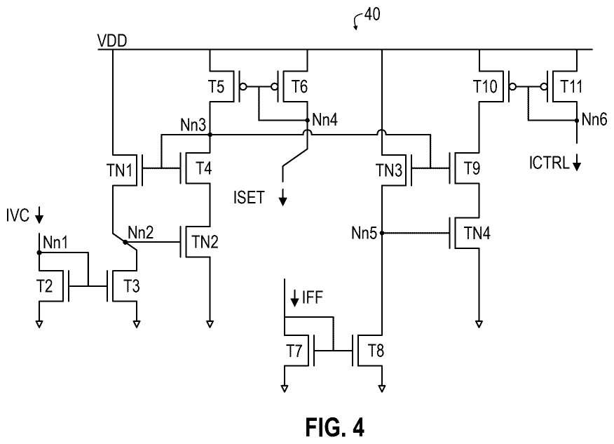

A specific example embodiment of the multiplier circuit 40 is now described with reference to FIG. 4. The multiplier circuit 40 includes a node Nn1 receiving the current IVC. N-channel transistors T2 and T3 are in a current mirroring relationship, and mirror a scaled version of the current IVC to be sunk from node Nn2. In greater detail, n-channel transistor T2 has its drain connected to node Nn1, its source connected to ground, and its gate connected to node Nn1 as well as to the gate of n-channel transistor T3. N-channel transistor T3 has its drain connected to node Nn2, its source connected to ground, and its gate connected to node Nn1 and the gate of n-channel transistor T2. N-channel transistor TN1 has its drain connected to the supply voltage VDD, its source connected to node Nn2, and its gate connected to the gate of n-channel transistor T4 as well as to node Nn3. N-channel transistor T4 has its drain connected to node Nn3, its source connected to the drain of n-channel transistor TN2, and its gate connected to the gate of n-channel transistor TN1 as well as to node Nn3. N-channel transistor TN2 has its drain connected to the source of n-channel transistor T4, its source connected to ground, and its gate connected to node Nn2.

P-channel transistors T5 and T6 form a current mirroring arrangement between nodes Nn3 and Nn4. In greater detail, p-channel transistor T5 has its source connected to the supply voltage VDD, its drain connected to node Nn3, and its gate connected to the gate of p-channel transistor T6 as well as to node Nn4. P-channel transistor T6 has its source connected to the supply voltage VDD, its drain connected to node Nn4, and its gate connected to the gate of p-channel transistor T5 as well as to node Nn4. The set current ISET is sunk from the drain of p-channel transistor T6 at node Nn4.

N-channel transistor TN3 has its drain connected to the supply voltage VDD, its source connected to node Nn5, and its gate connected to the gate of n-channel transistor T9 as well as to node Nn3. N-channel transistors T7 and T8 form a current mirroring arrangement to mirror a scaled version of the current IFF to be sunk from node Nn5. In greater detail, n-channel transistor T7 has its drain connected to receive current IFF, its source connected to ground, and its gate connected to its drain as well as to the gate of n-channel transistor T8. N-channel transistor T8 has its drain connected to node Nn5, its source connected to ground, and its gate connected to the gate and drain of n-channel transistor T7.

P-channel transistors T10 and TI1 are in a current mirroring arrangement to source the control current ICTRL to node Nn6 as output. In greater detail, p-channel transistor T10 has its source connected to the supply voltage VDD, its drain connected to the drain of n-channel transistor T9, and its gate connected to the gate of p-channel transistor TI1 as well as node Nn6. P-channel transistor T11 has its source connected to the supply voltage VDD, its drain connected to the gate as well as to node Nn6, and its gate connected to its drain as well as to the gate of p-channel transistor T10.

N-channel transistor T9 has its drain connected to the source of p-channel transistor T10, its source connected to the drain of n-channel transistor TN4, and its gate connected to the gate of n-channel transistor TN3 as well as to node Nn3. N-channel transistor TN4 has its drain connected to the source of n-channel transistor T9, its source connected to ground, and its gate connected to node Nn5.

The operation of the multiplier circuit 40 is now described. N-channel transistors T2 and T3 form a current mirror, scaling and replicating IVC at node Nn2. Transistors TN1, T4, and TN2 cooperate to convert the mirrored current at Nn2 into a voltage at node Nn3, which is proportional to IVC. P-channel transistors T5 and T6 mirror this current to node Nn4, where set current ISET is sunk, providing a bias point. Transistor TN3 converts the voltage at Nn3 back into a current at Nn5, which combines with the feedforward current IFF mirrored by transistors T7 and T8. Transistors T9 and TN4 cooperate to combine currents from previous stages. The output current mirror formed by p-channel transistors T10 and T11 provides the control current ICTRL at node Nn6. This circuit effectively multiplies IVC with the inverse of IFF (proportional to VIN), resulting in ICTRL being proportional to VOUT/VIN. Thus, the multiplier circuit 40 allows rapid duty cycle adjustments in response to input voltage variations in the DC-DC converter 5′.

Finally, it is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A circuit, comprising:
a DC-DC converter circuit configured to generate an output voltage from an input voltage; and
a control circuit coupled to the DC-DC converter circuit, the control circuit comprising:
a fast injection circuit configured to receive the input voltage and a driving signal;
a fine correction circuit coupled to the fast injection circuit;
a proportional-integral circuit; and
a phase detection circuit;
wherein the control circuit is configured to:
generate fast duty cycle variations in response to changes in the input voltage;
provide integral action to account for efficiency variations and eliminate steady-state errors; and
implement proportional and integral control, and generate a final driving signal based on outputs of the proportional-integral circuit, to thereby perform a proportional-integral-derivative filtering.

2. The circuit of claim 1, wherein the control circuit further comprises a low-pass filter coupled between the fast injection circuit and a reference voltage, the low-pass filter and fine correction circuit together creating a bandpass characteristic.

3. The circuit of claim 1, wherein the fast injection circuit comprises:
a voltage-to-current converter arrangement;
a current mirror coupled to the voltage-to-current converter arrangement; and
a multiplier circuit coupled to the current mirror.

4. The circuit of claim 3, wherein the multiplier circuit is configured to:
receive a current from the current mirror proportional to the input voltage;
receive a set current; and
generate a control current proportional to a ratio of the output voltage to the input voltage.

5. The circuit of claim 1, wherein the proportional-integral circuit comprises:
a first current controlled oscillator responsive to transconductance outputs provided by noninverting outputs of first and third transconductance amplifiers;
a second current controlled oscillator responsive to transconductance outputs provided by inverting outputs of the first and third transconductance amplifiers;
a first current controlled delay line responsive to transconductance outputs provided by noninverting outputs of second and fourth transconductance amplifiers; and
a second current controlled delay line responsive to transconductance outputs provided by inverting outputs of the second and fourth transconductance amplifiers.

6. The circuit of claim 5, wherein the proportional-integral circuit is configured to generate the driving signal based on outputs of the first and second current controlled delay lines.

7. A method of controlling a DC-DC converter, comprising:
generating fast variations in a driving signal duty cycle of the DC-DC converter in response to changes in an input voltage;
integrating an error between a feedback voltage and a reference voltage to account for efficiency variations of the DC-DC converter and eliminate steady-state output voltage errors;
implementing proportional and integral control on the error between the feedback voltage and the reference voltage;
generating a final driving signal for a power stage of the DC-DC converter based on outputs of the proportional and integral control; and
controlling the power stage of the DC-DC converter using the final driving signal to generate an output voltage from the input voltage.

8. The method of claim 7, further comprising:
creating a bandpass filtering for a feedforward signal by:
generating a control current proportional to a ratio of the output voltage to the input voltage;
injecting the control current into a low-pass filter to produce the feedforward signal; and
combining the low-pass filter with a fine correction circuit;
wherein the bandpass filtering optimizes the response of the DC-DC converter to different frequencies of disturbances in the input voltage and output voltage by rejecting high-frequency noise while allowing the DC-DC converter to respond to relevant frequency components of the disturbances.

9. The method of claim 8, wherein generating fast variations in the driving signal duty cycle comprises:
generating a current proportional to the input voltage using a voltage-to-current converter arrangement and a current mirror;
receiving a feedforward current as an input;
multiplying the current proportional to the input voltage with the feedforward current to generate the control current proportional to the ratio of the output voltage to the input voltage;
injecting the control current into the low-pass filter;
producing the feedforward signal as an output of the low-pass filter; and
using the feedforward signal to rapidly adjust the driving signal duty cycle in response to input voltage variations.

10. The method of claim 9, wherein implementing proportional and integral control comprises:
receiving the feedforward signal at non-inverting inputs of first and second transconductance amplifiers;
receiving the reference voltage at inverting inputs of the first and second transconductance amplifiers;
generating a first transconductance amplifier output and a second transconductance amplifier output from the first transconductance amplifier, and a third transconductance amplifier output and a fourth transconductance amplifier output from the second transconductance amplifier, based on a difference between the feedforward signal and the reference voltage;
generating oscillator signals using a feedback current controlled oscillator responsive to noninverting outputs of first and third transconductance amplifiers and a reference current controlled oscillator responsive to inverting outputs of the first and the third transconductance amplifier outputs;
delaying the oscillator signals using a feedback current controlled delay line responsive to noninverting outputs of second and fourth transconductance amplifiers and a reference current controlled delay line responsive to inverting outputs of the second and fourth transconductance amplifiers to produce phase-shifted signals; and
generating the final driving signal based on the phase-shifted signals using a phase-detection circuit.
